(19) United States
(12) Patent Application Publication
(10) Pub. No.: US 2010/0208236 A1
(43) Pub. Date: Aug. 19, 2010

(54) METHOD FOR DETERMINING THE POSITION OF AN OBJECT IN A STRUCTURE

(75) Inventors: Paulus Henricus Antonius Damink, Eindhoven (NL); Sel Brian Colak, Eindhoven (NL); Lorenzo Feri, Eindhoven (NL); Hendricus Theodorus Gerardus Maria Penning De Vries, Eindhoven (NL); Eduard Johannes Meijer, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/670,424

(22) PCT Filed: Jul. 28, 2008
(86) PCT No.: PCT/IB2008/053017

§ 371 Date: Jan. 25, 2010

(30) Foreign Application Priority Data
Aug. 1, 2007 (EP) 07113583.4

(51) Int. Cl. G01C 3/08

(52) U.S. Cl. 356/5.09

(57) ABSTRACT

This invention relates to a method for determining the position of an object in a structure. The object receives modulated light waves from a plurality of light sources, which are arranged in the structure. The modulation is individually coded, and the position of the light sources in the structure is known. The modulation signals are synchronized, and thereby it is possible to determine the position of the object on basis of measuring the phase difference between the phase of each received modulated light wave and a comparison phase. The phase difference is used for distance calculations, which in turn give the position of the object.

### FIELD OF THE INVENTION

The present invention relates to a method for determining the position of an object in a structure, which comprises a plurality of light sources emitting modulated light waves modulated by individually coded modulation signals, wherein the position of each light source in the structure is known. The method includes synchronizing the modulation signals, and receiving, at the object, a respective modulated light wave from at least several of said light sources.

### BACKGROUND OF THE INVENTION

It is widely recognized that controllable light sources, by means of which customized lighting environments can be created, are destined to become the main source of illumination for indoor and outdoor lighting applications. In order to obtain a good controllability the light sources are provided with individual identifiers, in the form of a modulation signal coding the light sources individually. That is, the light emitted from the light sources is coded. Normally the position of each light source has been determined, and is thus known.

Such individually identifiable light sources are in turn useful for determining the position of an object that is within the structure and that is provided with a detector for detecting light emitted by the light sources. By means of receiving coded light from several light sources and determining the distance to each light source, having a known position, it is possible to determine the position, either 2D or 3D position, of the object as well.

Some examples of known solutions for determining the position of an object by means of coded light sources having known positions are disclosed in the U.S. Pat. No. 6,865,347. One of the disclosed solutions utilise the coded light from several light sources in combination with received signal strength of the coded light. Relying on the received signal strength, which is attenuated over distance, gives a rather inaccurate position and necessitates additional knowledge about the transmitted signal strength as well. Another solution that is proposed in U.S. Pat. No. 6,865,347 is a specially designed light detector, which due to its geometrical construction generates angular data that makes it possible to detect light from a single light source in order to make a 3D position determination. This alternative solution also uses receive signal strength (RSS) to determine the distance to the light source, and has a relatively complicated construction. Yet another alternative that is given is to employ time delay measurements, i.e. the time it takes for the coded light to travel from the light source to the detector is determined for several light sources. This solution has the drawbacks of requiring a fully synchronized system and very high frequency measurements in order to detect the propagation time and convert that time into a distance with good accuracy.

### SUMMARY OF THE INVENTION

It is an object of the invention to provide a method for determining the position of an object in a structure that alleviates the above-mentioned drawbacks of the prior art and provides a method for accurate position determination at a reasonably high frequency.

This object is achieved by a method for determining the position of an object according to the present invention as defined in claim 1.

Thus, in accordance with an aspect of the invention, there is provided a method for determining the position of an object in a structure, which comprises a plurality of light sources emitting modulated light waves that are modulated by individually coded modulation signals, wherein the position of each light source in the structure is known. The method comprises:
synchronizing the modulation signals;
receiving, at the object, a respective modulated light wave from at least several of said light sources;
determining the position of the object on basis of measuring the phase difference between the phase of each received modulated light wave and a comparison phase, and determining a distance by means of said phase difference.

By measuring phase differences between the modulation signals and a phase reference in order to determine distances to be used in the position determination, the operating frequency involved does not have to be as high as in RF measurements or the above-mentioned propagation time measurement. Still the inventive method provides high position accuracy.

It should be noted that by the term “structure” means any structure that is arranged to carry light sources of the kind of interest, including but not limited to, a building, a room in a building, a vehicle, wall-less roofed areas, etc.

In accordance with an embodiment of the method, as defined in claim 2, it involves obtaining the comparison phase from a reference signal, which is synchronized with the modulation signals. The synchronization provides for a relatively simple determination of the phase difference, as will be readily understood by a skilled person.

In accordance with an embodiment of the method as defined in claim 3, the distance is the distance between the object and the light source that has emitted the associated modulated light wave. Provided that the just mentioned synchronization is utilized this is the most direct and simple, and thus advantageous, way to determine the position of the object. Furthermore, for determining a 3D position the determined distances between the object and at least three different ones of said plurality of light sources are employed.

In accordance with an embodiment of the method, as defined in claim 5, the comparison phase is obtained from another received modulated light wave. In this embodiment there is no need for a (external) synchronized reference signal, since the modulation signals are mutually compared.

In accordance with an embodiment of the method, as defined in claim 6, provided that the just mentioned comparison between modulation signals is used, the determination of the position of the object preferably comprises:
employing the modulated light waves from at least four different light sources for measuring at least three different phase differences, which are used for determining at least three distances, and;
employing the determined distances for determining a 3D position of the object.

In accordance with an embodiment of the method, as defined in claim 7, several 3D positions are determined by means of different combinations of modulated light waves, and these several 3D positions are used for optimizing the estimated 3D position. This provides for an additionally increased accuracy.

These and other aspects, features, and advantages of the invention will be apparent from and elucidated with reference to the embodiments described hereinafter.

### BRIEF DESCRIPTION OF THE DRAWINGS

The invention will now be described in more detail and with reference to the appended drawings in which:

FIG. 1 schematically illustrates an object in a structure having several light sources installed;

FIGS. 2 and 3 are flow charts illustrating embodiments of the method for determining a position of an object in a structure according to the present invention; and

FIG. 4 is a schematic block diagram of an embodiment of a light detecting object and system according to the present invention.

### DESCRIPTION OF PREFERRED EMBODIMENTS

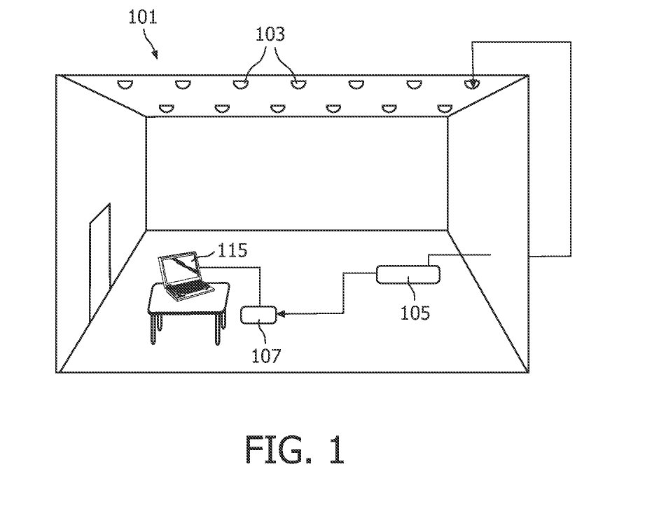

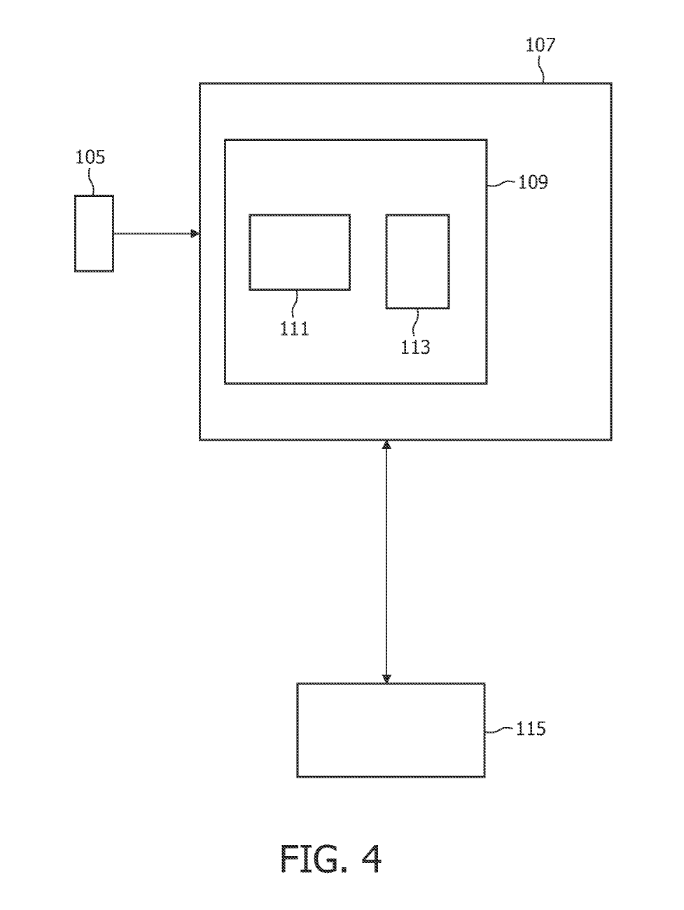

A first embodiment of the method for determining the position of an object in a structure, as shown in FIG. 1, is applicable to a structure 101 where several light sources 103 are arranged, for example in the ceiling (or wall) of a room. An object 107 is in the structure 101. An embodiment of a position determination apparatus 109 provided in the object 107 comprises, as illustrated in FIG. 4, a light detector 111, such as for example a photodiode, and a processor 113, such as a DSP or a CPU. The light sources 103, which could typically be LEDs, are synchronized by a reference clock signal, or simply reference clock, generated by a reference clock signal generator 105. Further, the light detector 111 is also synchronized by the reference clock. The synchronization can be made in any appropriate way as known to a person skilled in the art, wherein the reference signal generator 105 can be a separate device arranged in the structure 101 or be a virtual device representing a common reference clock. Thus, for example a dedicated wire is used for feeding the reference clock to each device (i.e. light source or detector); the reference clock is transported over the power lines, i.e. the mains; the common 50 or 60 Hz of the power lines is used to generate the reference clock; or a reference clock is transmitted wirelessly to the devices.

Moreover, each light source 103 has a unique identity, which is provided by embedding an individual code in the light emitted from the light source 103. Preferably, the individual coding is obtained by modulating the light with an individually coded modulation signal, preferably a CDMA signal.

Further, the position of each light source 103 of the structure 101 is known in advance. This knowledge is obtainable in different ways as known to a skilled person. Typically, the positions where light sources 103 are to be mounted are identified already on a layout of the structure 101, and there are different techniques for determining which one of the individual light sources 103 has been mounted in which position.

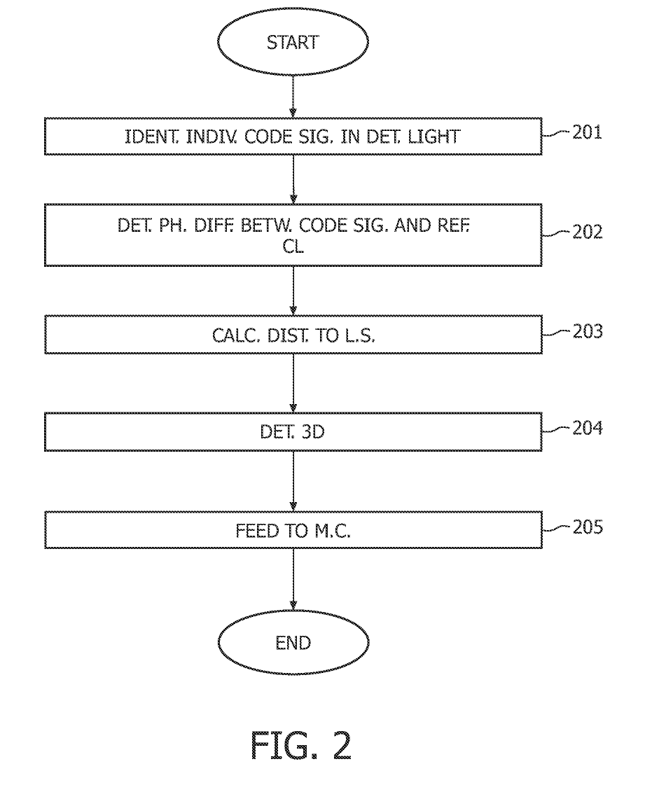

The position of the object 107 is determined in the following way, as illustrated with the flow chart of FIG. 2. It is assumed that a 3D position, i.e. a 3D coordinate, is to be determined. The light of at least three different light sources has to reach the detector 111. The different light sources 103 which have emitted the detected light are identified by their individual code signals, at step 201. The phases of the code signals associated with at least three different light sources are each compared with the reference clock, and the phase differences are determined, at step 202. Since the code signal frequency, such as the CDMA modulation frequency, is known, it is possible to calculate the distance to each one of the at least three light sources, at step 203. The distances and the known positions of the light sources 103 are then used to determine the 3D position of the detector 111, i.e. of the object 107. These calculations per se are rather easy to perform by a skilled person who has gained knowledge about the general inventive concept as described herein, and will therefore not be described in detail. The 3D position is then transmitted from the position determination apparatus 109 to a master controller 115 where it is either displayed or used for monitoring purposes or any other suitable purpose. Additionally, or as an alternative, the object itself is provided with a display, which displays its position. There are several possible applications of the invention, for instance asset tracking, visitor guidance, guidance system for blind people, etc.

In a second embodiment of the method, the light sources 103 are not synchronized with the light detector 111, but are still mutually synchronized. Then it is a bit more complicated to determine an accurate position. Let us still assume that a 3D position is to be achieved. The light emitted from at least four light sources 103 is needed. By measuring the phase differences between two code signals, the difference in length between the corresponding light sources and the detector 111 is calculated. By calculating at least three such phase differences, i.e. between said at least four light sources 103, it is possible to solving an equation system which gives the distances between the object 107 and the light sources, whereby the 3D position of the object is determined like above.

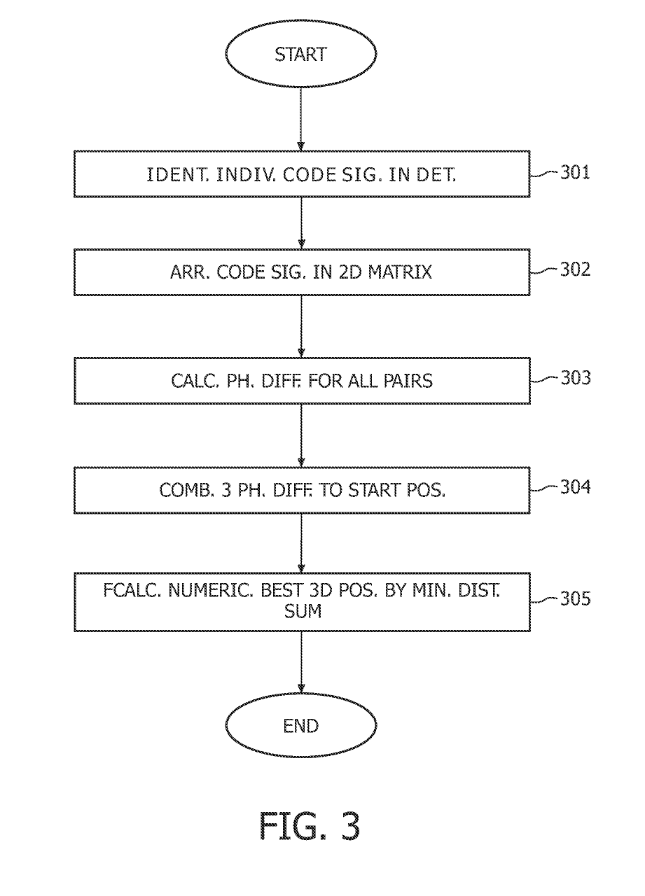

However, to obtain a more accurate result, according to a third embodiment, the following steps are performed. First all individual code signals in the detected light are identified, at step 301 (FIG. 3). A 2D matrix is then arranged of all possible pairs of code signals, at step 302. At step 303, the phase difference is calculated for each pair. An arbitrary combination of three phase differences is used for calculating a first 3D position. Using a numerical procedure for calculating the distance from the first 3D position to each one of all other possible positions, results in finding a position with a minimum for the sum of the distances.

There are several alternative methods to the second embodiment for determining the position when the detector 111 is not synchronized with the light sources 103. Thus, an alternative method is to repeat the steps of the second embodiment above for all possible combinations of 4 light sources 103 and then average the results. Another embodiment includes detecting the intensity of the light of each detected light source. The steps of the second embodiment are performed for different pairs of four light sources 103 and the difference in calculated coordinates is determined; for each determination of the difference the light source of the highest detected intensity is left. This procedure is continued until an average stabilizes.

It should be noted that the above synchronization of the light sources 103, or of the modulation signals, preferably constitutes, or comprise, phase synchronization. Above, embodiments of the method according to the invention as defined in the appended claims have been described. These should be seen as merely non-limiting examples. As understood by a skilled person, many modifications and alternative embodiments are possible within the scope of the invention.

For example, the inventive method may be applied in a detector comprising colour sensors to be used in controlling (e.g. colour stabilization) the lighting system in the structure 101. Often such colour sensors employ filtering technologies having considerable angle of incidence dependence. An example of such an angle of incident depending filtering technology is an interference filter comprising a stack of layers with an alternating high/low index of refraction. Such filters have a different optical response for light hitting the filter under different angles. With known positions of the light sources 103 and a determined position of the object 107/detector, the angle of incidence of the light originating form the light sources can be inferred. Hence, the inventive method enables a correction for the angle of incidence dependence of the applied filter. Advantageously, this improves the accurate determination and control of the colour setting of the light sources 103.

Thus, as explained by means of the embodiments above, the invention regards a method for determining the position of an object in a structure. The object receives modulated light waves from several light sources, which are arranged in the structure. The modulation is individually coded, and the position of the light sources in the structure is known. The modulation signals are synchronized, and thereby it is possible to determine the position of the object on basis of measuring the phase difference between the phase of each received modulated light wave and a comparison phase. The phase difference is used for distance calculations, which in turn give the position of the object.

It is to be noted, that for the purposes of this application, and in particular with regard to the appended claims, the word “comprising” does not exclude other elements or steps, that the word “a” or “an”, does not exclude a plurality, which per se will be apparent to a person skilled in the art.

1. A method for determining the position of an object (107) in a structure (101), which comprises a plurality of light sources (103) emitting modulated light waves that are modulated by individually coded modulation signals, wherein the position of each light source (103) in the structure (101) is known, comprising:
synchronizing the modulation signals, and
receiving, at the object (107), a respective modulated light wave from at least several of said light sources (103), characterized by:
determining the position of the object (107) on the basis of measuring the phase difference between the phase of each received modulated light wave and a comparison phase, and determining a distance by means of said phase difference.

2. A method according to claim 1, comprising obtaining said comparison phase from a reference signal, which is synchronized with the modulation signals.

3. A method according to claim 2, wherein said distance is the distance between the object (107) and the light source (103) that has emitted the associated modulated light wave.

4. A method according to claim 3, wherein said determination of the position of the object (107) comprises employing the determined distances between the object (107) and at least three different ones of said plurality of light sources (103) for determining a 3D position of the object (107).

5. A method according to claim 1, comprising obtaining said comparison phase from another received modulated light wave.

6. A method according to claim 5, wherein said determination of the position of the object (107) comprises:
employing the modulated light waves from at least four different light sources (103) for measuring at least three different phase differences, which are used for determining at least three distances, and;
employing the determined distances for determining a 3D position of the object (107).

7. A method according to claim 6, comprising determining several 3D positions on the basis of different combinations of modulated light waves, and optimizing the estimated 3D position on the basis of said several 3D positions.
